(19) United States
(12) Patent Application Publication
(10) Pub. No.: US 2004/0030958 A1
(43) Pub. Date: Feb. 12, 2004

(54) Integrated circuit with direct debugging architecture

(76) Inventor: Erik Moerman, Merelbeke (BE)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/402,376

(22) Filed: Mar. 28, 2003

(30) Foreign Application Priority Data
Mar. 29, 2002 (EP) 02290812.3

(51) Int. Cl. H02H 3/05

(52) U.S. Cl. 714/30

(57) ABSTRACT

An integrated circuit comprising a main section/processor and a subsection/subprocessor for debugging the main section is provided with hardware modules coupled via a subbus to said subprocessor and coupled to different parts of said main section, for debugging more directly. The hardware modules comprise a shiftregister coupled to a chain unit and a clock controller coupled to a clock generator for scanning purposes, a scan controller coupled to said chain unit for selection scanning options, a breakpoint controller coupled to said chain unit for interrupting said scanning, and/or a programmable register coupled to dedicated hardware for tracing purposes. An access module is coupled to an interface for communication with the outside world and is further coupled to an access memory. A subprocessor memory stores amendable/replacable software for controlling said subsection and said debugging as well as a transmission of debugging results via said access module to an external debugger.

### BACKGROUND OF THE INVENTION

1. Field of the Invention

The invention relates to an integrated circuit comprising a main section with a main processing functionality and a subsection with a subprocessor for debugging at least a part of said main section as well as a method of operating the same and software for use with the same.

2. Technical Background

An integrated circuit comprising a main section with a main processing functionality and a subsection with a subprocessor for debugging at least a part of said main section is for example a chip like for example an Application Specific Integrated Circuit or ASIC.

A prior art integrated circuit is known from U.S. Pat. No. 5,566,303, which dicloses in its FIG. 12 a main section (right part) with a main processor (main Central Processing Unit or main CPU performing a main processing functionality) and a subsection (left part) with a subprocessor (subCPU). This subCPU debugs the main section via a Random Access Memory or RAM and a Read Only Memory or ROM, both coupled to the same main CPU bus.

The known integrated circuit is disadvantageous, inter alia, due to debugging indirectly: both memories read the main CPU bus and store the information read from the main CPU bus, after which the subCPU processes the information read.

### SUMMARY OF THE INVENTION

It is an object of the invention, inter alia, of providing an integrated circuit and a method of operating the same which can debug more directly.

In one aspect a subsection of an integrated circuit according to the present invention comprises at least two hardware modules coupled via a subbus to a subprocessor. The at least hardware modules may also be coupled to different parts of a main section.

By introducing two or more hardware modules coupled to said subbus for communication with said subprocessor and coupled to different parts of said main section for communication with these different parts, the debugging is more direct compared to the prior art situation where a RAM and a ROM are just looking at the main CPU bus.

The invention is based upon an insight, inter alia and without being limited by theory, that prior art debugging architectures having a main processing functionality and a subprocessor are software oriented and therefore slow, and is based upon a basic idea, inter alia, that new debugging architectures should be more hardware oriented, which is faster.

The invention solves the problem, inter alia, of providing an integrated circuit as defined in the preamble which can debug more directly.

Said main processing functionality is usually realised via a main processor, but alternatives, like for example groups of flip flops controlled by one or more clock generators with one or more memories for storing results of processing functions performed by said flip flops, are not to be excluded. So, said main processing functionality is not to be limited to CPUs.

A first embodiment of the integrated circuit according to the invention is advantageous in that a first hardware module comprises a shiftregister coupled to a chain unit located in said main section, with a second hardware module comprising a clock controller coupled to a clock generator located in said main section.

By introducing said shiftregister coupled to the chain unit located in the main section and for example comprising at least one chain router and at least one scan chain, a direct communication between said shift register and said chain unit has become possible, for scanning purposes for example. During scanning, the clock generator in the main section needs to be stopped, and flip flops in one or more scan chains need to be provided with a further clock signal, which all is taken care of by said clock controller.

A second embodiment of the integrated circuit according to the invention is advantageous in that a third hardware module comprises a scan controller coupled to said chain unit.

By introducing said scan controller coupled to said subbus and to said chain unit, one or more scan chains can be selected and/or one or more flip flops in one scan chain can be selected, which makes said debugging more direct.

A third embodiment of the integrated circuit according to the invention is advantageous in that a fourth hardware module comprises a breakpoint controller coupled to said chain unit.

By introducing said breakpoint controller coupled to said subbus and to said chain unit, either a breakpoint signal present at said subbus or a breakpoint signal present in said chain unit can be detected for requesting an interruption of said scanning.

A fourth embodiment of the integrated circuit according to the invention is advantageous in that a fifth hardware module comprises a programmable register coupled to dedicated hardware located in said main section.

By introducing said programmable register coupled to said subbus and to said dedicated hardware like for example busses, flip flops and/or shadow registers all located in said main section, a direct communication between said programmable register and said dedicated hardware has become possible, for tracing purposes for example. During tracing, said clock generator in said main section is usually not stopped.

A fifth embodiment of the integrated circuit according to the invention is advantageous in that said integrated circuit comprises an access module coupled to an interface located in said subsection, which interface is further coupled to said subbus.

By introducing said access module, located either in said main section or in said subsection or in a further section, communication with the outside world has become possible. Said interface coupled to said subbus and to said access module allows said subprocessor and said access module to communicate with each other.

A sixth embodiment of the integrated circuit according to the invention is advantageous in that said access module is further coupled to an access memory located in said subsection, which access memory is further coupled to said subbus.

By introducing said access memory coupled to said subbus and to said access module, direct communication between said access module and said access memory has become possible, under control of said subprocessor via said interface.

A seventh embodiment of the integrated circuit according to the invention is advantageous in that said subsection comprises a subprocessor memory coupled to said subbus for storing software.

By introducing said subprocessor memory coupled to said subbus, software can be stored, for controlling (via said subprocessor) said subsection.

A eighth embodiment of the integrated circuit according to the invention is advantageous in that said software in said subprocessor memory controls said debugging as well as a transmission of debugging results via said access module to an external debugger.

A ninth embodiment of the integrated circuit according to the invention is advantageous in that said software is amendable/replacable software with amendments/replacements arriving via said access module and originating from said external debugger.

By introducing said amendable and/or replacable software with amendments and/or replacements arriving via said access module and originating from said external debugger, said software can be updated.

The present invention also includes software for controlling (via said subprocessor) debugging, like for example scanning and/or tracing. It can also control (via said subprocessor) transmission of debugging results to the outside world like for example to an external debugger. An advantage is that a subsection can take care of smaller problems without informing the outside world, with just the bigger problems being communicated with said outside world. The software may be stored in the form of code on any suitable signal media such as magnetic tape, magnetic disk, hard disk, optical disk such as CD-ROM or DVD-ROM, diskette or in the memory of a computing device.

The present invention also includes a method of operation of an integrated circuit comprising a main section and a subsection with a subprocessor, wherein said subsection comprises at least two hardware modules coupled via a subbus to said subprocessor and coupled to different parts of said main section, the method comprising direct debugging of at least a part of said main section.

It should be noted that said different parts do not exclude that two hardware modules are further coupled to the same part. Said shiftregister is coupled to the chain unit, said clock controller is coupled to said clock generator, said scan controller is coupled to said chain unit, said breakpoint controller is coupled to said chain unit, and said programmable register is coupled to dedicated hardware located in said main section like for example busses, flip flops and/or shadow registers all located in said main section. So, the different parts comprise the chain unit, the clock generator and the dedicated hardware, but firstly further different parts are not to be excluded, like for example different parts located inside said chain unit, and secondly said two or more hardware modules coupled to different parts may further be coupled to the same part, like for example in case of one or more flip flops in said chain unit corresponding with one or more flip flops in said dedicated hardware.

These and other aspects of the invention will be apparent from and elucidated with reference to the embodiments(s) described hereinafter.

### BRIEF DESCRIPTION OF THE DRAWINGS

FIG. 1 illustrates in block diagram form an integrated circuit according to an embodiment of the present invention.

### DETAILED DESCRIPTION

The present invention will be described with respect to particular embodiments and with reference to a certain drawing but the invention is not limited thereto but only by the claims. The drawing described is only schematic and is non-limiting. In the drawing, the size of some of the elements may be exaggerated and not drawn on scale for illustrative purposes.

Furthermore, the terms first, second and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter. Thus, the scope of the expression “a device comprising means A and B” should not be limited to devices consisting only of components A and B. It means that with respect to the present invention, the only relevant components of the device are A and B.

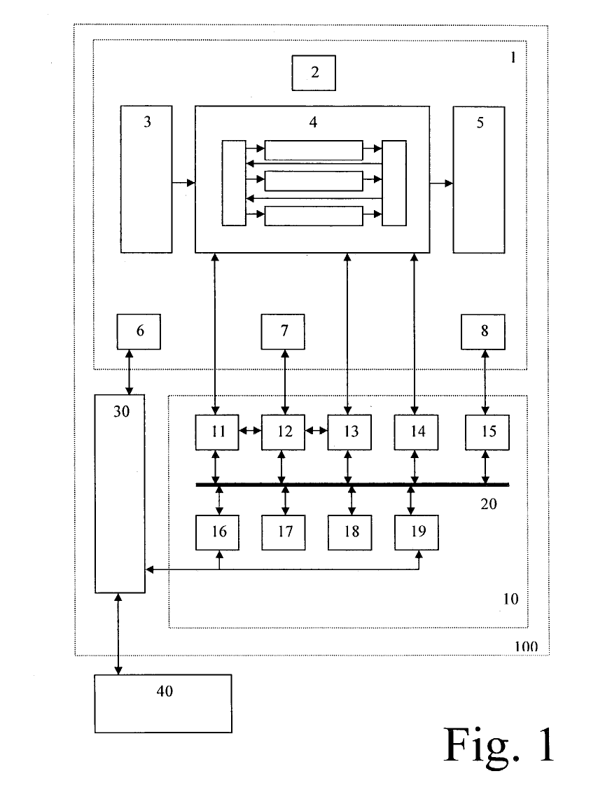

FIG. 1 illustrates an integrated circuit 100 comprising a main section 1 with a main processor 2 and comprising a subsection 10 with a subprocessor 18 and comprising an access module 30. The integrated circuit 100 is coupled to an external debugger 40.

Main section 1 further comprises ATPG modules 3 and 5 (automatic test pattern generation modules), with chain unit 4 located between both ATPG modules 3 and 5 and comprising for example two chain routers coupled via three scan chains. Of course, in practice, there could be one to a thousand or more scan chains. Main section 1 also comprises (access module controlled) block 6, clock generator 7 and dedicated hardware 8.

Subsection 10 further comprises five hardware modules 11-15 all coupled to a subbus 20, with hardware module 11 being a breakpoint controller II further coupled to chain unit 4, with hardware module 12 being a clock controller 12 further coupled to clock generator 7 and further coupled to breakpoint controller 11, with hardware module 13 being a scan controller 13 further coupled to chain unit 4 and further coupled to clock controller 12, with hardware module 14 being a shift register 14 further coupled to chain unit 4, and with hardware module 15 being a programmable register 15 further coupled to dedicated hardware 8. Subsection 10 also comprises an access memory 16, a subprocessor memory 17, said subprocessor 18 and an interface 19, all coupled to said subbus 20, and with access memory 16 and interface 19 further being coupled to an access module 30, which is further coupled to said block 6 (being an access module controlled block) located in main section 1, and to said external debugger 40.

The invention relates to an integrated circuit 100 comprising a main section 1 with a main processing functionality for example realised via main processor 2 and a subsection 10 with a subprocessor 18 for debugging at least a part (4 and/or 8) of said main section 1.

Such an integrated circuit 100 is for example a chip like for example an Application Specific Integrated Circuit or ASIC. Said chain unit 4 for example comprises and/or is coupled to flip flops, and said dedicated hardware 8 for example comprises and/or is coupled to busses, flip flops and/or shadow registers. All flip flops, busses and shadow registers, together with main processor 2, perform ASIC functions (main processing functionality), with said ASIC forming part of a mobile phone, video card, personal computer, telephone exchange etc. Said flip flops, busses and shadow registers can be additional to main processor 2, but it is not to be excluded that at least some of them form part of main processor 2.

A prior art integrated circuit is known from U.S. Pat. No. 5,566,303, which discloses in its FIG. 12 a main section (right part) with a main processor (main Central Processing Unit or main CPU performing a main processing functionality) and a subsection (left part) with a subprocessor (subCPU). This subCPU debugs the main section via a Random Access Memory or RAM and a Read Only Memory or ROM, both coupled to the same main CPU bus.

In the integrated circuit 100 according to the invention, subsection 10 comprises at least two hardware modules 11-15 coupled via a subbus 20 to said subprocessor 18 and coupled to different parts (4,7,8) of said main section 1.

By introducing two or more hardware modules 11-15 coupled to said subbus 20 for communication with said subprocessor 18 and coupled to different parts (4,7,8) of said main section 1 for communication with these different parts (4,7,8), the debugging is more direct compared to the prior art situation where a RAM and a ROM are just looking at the main CPU bus.

A first hardware module comprises a shiftregister 14 coupled to a chain unit 4 located in said main section 1, which chain unit 4 for example comprises at least one chain router and at least one scan chain. A second hardware module comprises a clock controller 12 coupled to a clock generator 7 located in said main section 1, to make a direct communication between said shift register and said chain unit possible, for scanning purposes for example. During scanning, the clock generator 7 in the main section needs to be stopped, and flip flops in one or more scan chains need to be provided with a further clock signal, which all is taken care of by said clock controller 12. Said scanning is described in more detail below.

A third hardware module comprises a scan controller 13 coupled to said chain unit 4, for selecting one or more scan chains and/or one or more flip flops in one scan chain. This makes said debugging more direct.

A fourth hardware module comprises a breakpoint controller 11 coupled to said chain unit 4, for detecting either a breakpoint signal present at said subbus 20 or a breakpoint signal present in said chain unit 4, for requesting an interruption of said scanning.

A fifth hardware module comprises a programmable register 15 coupled to dedicated hardware 8, like for example busses, flip flops and/or shadow registers all located in said main section 1, to make a direct communication between said programmable register 15 and said dedicated hardware 8 possible, for tracing purposes for example. During tracing, said clock generator 7 in said main section usually is not stopped. Said tracing is described in more detail below.

An access module 30 is coupled to an interface 19 located in said subsection 10, which interface 19 is further coupled to said subbus 20, to make communication with the outside world possible. Said access module 30 is located either in said main section 1 or in said subsection 10 or in a further section. Said interface 19 coupled to said subbus 20 and to said access module 30 allows said subprocessor 18 and said access module 30 to communicate with each other.

Said access module 30 is further coupled to an access memory 16 located in said subsection, which access memory 16 is further coupled to said subbus 20, to make direct communication between said access module 30 and said access memory 16 possible, under control of said subprocessor 18 via said interface 19.

Said subsection 10 comprises a subprocessor memory 17 coupled to said subbus 20 for storing software, for controlling (via said subprocessor 18) said subsection 10.

Said software in said subprocessor memory 16 controls said debugging as well as a transmission of debugging results via said access module 30 to an external debugger 40. By introducing said software for controlling (via said subprocessor 18) said debugging like for example said scanning and/or said tracing and for controlling (via said subprocessor 18) said transmission of debugging results to the outside world like for example said external debugger 40, the subsection 10 can take care of smaller problems without informing the outside world, with just the bigger problems being communicated with said outside world.

Said software is amendable/replacable software with amendments/ replacements arriving via said access module 30 and originating from said external debugger 40. By introducing said amendable and/or replacable software with amendments and/or replacements arriving via said access module 30 and originating from said external debugger 40, said software can be updated.

It should be noted that said different parts do not exclude that two hardware modules 11-15 are further coupled to the same part. Said shiftregister 14 is coupled to the chain unit 4, said clock controller 12 is coupled to said clock generator 7, said scan controller 13 is coupled to said chain unit 4, said breakpoint controller 11 is coupled to said chain unit 4, and said programmable register 15 is coupled to dedicated hardware 8 located in said main section I like for example busses, flip flops and/or shadow registers all located in said main section 1. So, the different parts comprise the chain unit 4, the clock generator 7 and the dedicated hardware 8, but firstly further different parts are not to be excluded, like for example different parts located inside said chain unit 4, and secondly said two or more hardware modules 11-15 coupled to different parts may further be coupled to the same part, like for example in case of one or more flip flops in said chain unit 4 corresponding with one or more flip flops in said dedicated hardware 8.

It should further be noted that two or more of said hardware modules 11-15 can be combined with each other and that access memory 16 and subprocessor memory 17 can be combined with each other, without departing from the scope of this invention. In fact, especially in said subsection 10, any two or more blocks can be combined with each other, and any one block can be divided into two subblocks, 30 without departing from the scope of this invention.

When scanning, usually not done real-time and being a low speed process, the following happens. Either in response to an activation signal from the outside world arriving via external debugger 40, access module 30, and either access memory 16 or interface 19, and subbus 20, or in response to a timing signal generated in subsection 10, or in response to an indication signal generated in main section 1 and supplied via either access module 30 or one of said hardware modules 11-15, scanning software stored in subprocessor memory 17 is activated. As a result, subprocessor 18 controls via subbus 20 breakpoint controller 11 which is trying to find a match between signals present on subbus 20 or present in chain unit 4 and predefined signals, and which informs subprocessor 16 of each matching result. Subprocessor 18 further controls via subbus 20 clock controller 12, which in response stops clock generator 7 and possibly supplies its own clock pulses to chain unit 4, for example via scan controller 13. Subprocessor 18 further controls via subbus 20 scan controller 13 and shift register 14 in such a way that scan controller controls chain unit such that certain scan chains (usually comprising flip flops) or parts of scan chains (usually flip flops) are scanned, thereby possibly using said clock pulses originating from clock controller 12, and with shift register 14 receiving the information from said selected flip flops for reading purposes. Said scanning software processes said information, and decides whether it is necessary to amend information in said main section 1, to be done under control of subprocessor 18 and via shift register 14, and decides whether the outside world needs to be informed of the debugging results, in case of smaller problems this is usually not necessary, in case of bigger problems this is usually necessary. This deciding, compared to prior art solutions, allows the subsection 10 to use a higher speed.

So, with scan controller 13 just the interesting parts can be selected to be scanned, which saves a lot of time. Further, via scan controller 13 and said chain routers, each flip flop in said main section 1 can be scanned.

When tracing, usually done real-time and being a high speed process, the following happens. Either in response to an activation signal from the outside world arriving via external debugger 40, access module 30, and either access memory 16 or interface 19, and subbus 20, or in response to a timing signal generated in subsection 10, or in response to an indication signal generated in main section I and supplied via either access module 30 or one of said hardware modules 11-15, tracing software stored in subprocessor memory 17 is activated. As a result, subprocessor 18 controls via subbus 20 programmable register 15, which starts tracing (monitoring) dedicated hardware 8, for example comprising one or more busses, one or more flip flops and/or one or more shadow registers all located in said main section 1. Said programmable register 15 has some decision authority, and can start/stop the tracing and (temporarily) store some tracing results without informing subprocessor 18. In case programmable register 15 has decided that subprocessor 18 needs to be informed, this is done via subbus 20, and information is supplied to subprocessor 18. Then said tracing software processes said information, and decides whether the outside world needs to be informed of the debugging results, in case of smaller problems this is usually not necessary, in case of bigger problems this is usually necessary. This deciding, compared to prior art solutions, allows the subsection 10 to use a higher speed.

Said scanning software and said tracing software can be updated via access module 30 and external debugger 40. Interface 19 for example being a peek/poke register will thereby prevent that the updating will slow down the functioning of the subsection.

Summarizing, the integrated circuit 100 according to the invention combines speed, flexibility and efficiency, and will allow the production of better and more efficient ASICs.

Having thus described at least one illustrative embodiment of the invention, various alterations, modifications, and improvements will readily occur to those skilled in the art. Such alterations, modifications, and improvements are intended to be within and scope of the invention. Accordingly, the foregoing description is by way of example only and is not intended as limiting. The invention is limited only as defined in the following claims and the equivalents thereto.

What is claimed is:

1. Integrated circuit comprising a main section with a main processing functionality and a subsection with a subprocessor for debugging at least a part of said main section, wherein said subsection comprises at least two hardware modules coupled via a subbus to said subprocessor and coupled to different parts of said main section.

2. Integrated circuit according to claim 1, wherein a first hardware module comprises a shiftregister coupled to a chain unit located in said main section, with a second hardware module comprising a clock controller coupled to a clock generator located in said main section.

3. Integrated circuit according to claim 2, wherein a third hardware module comprises a scan controller coupled to said chain unit.

4. Integrated circuit according to claim 2, wherein a fourth hardware module comprises a breakpoint controller coupled to said chain unit.

5. Integrated circuit according to claim 3, wherein a fourth hardware module comprises a breakpoint controller coupled to said chain unit.

6. Integrated circuit according to claim 2, wherein a fifth hardware module comprises a programmable register coupled to dedicated hardware located in said main section.

7. Integrated circuit according to claim 3, wherein a fifth hardware module comprises a programmable register coupled to dedicated hardware located in said main section.

8. Integrated circuit according to claim 4, wherein a fifth hardware module comprises a programmable register coupled to dedicated hardware located in said main section.

9. Integrated circuit according to claim 1, wherein said integrated circuit comprises an access module coupled to an interface located in said subsection, which interface is further coupled to said subbus.

10. Integrated circuit according to claim 8, wherein said access module is further coupled to an access memory located in said subsection, which access memory is further coupled to said subbus.

11. Integrated circuit according to claim 9, wherein said subsection comprises a subprocessor memory coupled to said subbus for storing software.

12. Integrated circuit according to claim 10, wherein said software in said subprocessor memory controls said debugging as well as a transmission of debugging results via said access module to an external debugger.

13. Integrated circuit according to claim 11, wherein said software is amendable/replacable software with amendments/replacements arriving via said access module and originating from said external debugger.

14. A method of operation of an integrated circuit comprising a main section and a subsection with a subprocessor, wherein said subsection comprises at least two hardware modules coupled via a subbus to said subprocessor and coupled to different parts of said main section, the method comprising direct debugging of at least a part of said main section.

15. The method according to claim 13, wherein the debugging comprises one of scanning and tracing.

16. Software product for controlling an integrated circuit comprising a main section and a subsection with a subprocessor, wherein said subsection comprises at least two hardware modules coupled via a subbus to said subprocessor and coupled to different parts of said main section, the software comprising code for direct debugging of at least a part of said main section.

17. Software product as defined in claim 16, further comprising code for transmission of debugging results via an access module to external.

18. Software according to claim 16, wherein the debugging comprises one of scanning and tracing.
